(19) United States
(12) Patent Application Publication
(10) Pub. No.: US 2011/0208351 A1
(43) Pub. Date: Aug. 25, 2011

(54) PERSONAL MEDICATION REGIMEN CONTROL SYSTEM

(76) Inventors: Hermano da Costa Ribeiro, Brasilia (BR); Jose Daniel Martin Catoira, Brasilia (BR)

(21) Appl. No.: 13/031,949

(22) Filed: Feb. 22, 2011

(30) Foreign Application Priority Data
Feb. 22, 2010 (BR) PI1001369-5

(51) Int. Cl. G06F 17/00

(52) U.S. Cl. 700/242

(57) ABSTRACT

A personal medication regimen control system includes a pocket scheduler size or similar small container, divided into compartment recesses that allow it to separately store different types of medication as well as detect the presence of the medication in the recesses, warn the user of times and dates to use the medication and establish communication locally and remotely through cellular or similar remote communication that will allow third parties such as caregivers, pharmacists, nurses and physicians to participate and ensure accurate compliance with medical instructions and replenishing of medication supply for the patient.

### SUMMARY AND BACKGROUND

The present disclosure describes a system having an electronic device which is inserted into a box or special container which is divided in smaller compartments, referred to as recesses, in which different medications will be placed in order to allow a patient to follow a medication regimen as prescribed by their physician. This multi-compartmental container includes an electronic circuit having a series of sensors, according to the desired model and complexity, to sense the presence of medication in a pre-determined compartment or recess. The circuit includes a microcontroller used with the sensors to register and update the sequence, frequency, clock time and other inputs about the medication used by the patient, in order to relay information related to time and date of medication used as well as to the need to refill the container with more medication. The microcontroller will also warn the patient on a regular basis of the date and time to take a certain medication.

There is mounting literature regarding the problem of poor patient compliance with medications, specifically medications used to treat chronic asymptomatic diseases where the patient does not feel the need for the medication on a daily basis. Those patients tend to forget to take or refill their medications, leading to poorer outcomes related to poor control of diseases such as systemic hypertension, diabetes, hypercholesterolemia, which are risk factors for death by heart disease and stroke. The currently available simple medication boxes available with days of the week labeled on the top allow the medications to be kept in a clean place and to be taken according to the days of the week by the patient or caregiver; however, they do not allow control or improvement of compliance or any information as to refill of medication needed.

The presently disclosed system will improve medication regimen compliance by allowing follow-up by the doctor, nurse or pharmacist, in real time, with dates and times of medication intake, as well as information about need for refill of medications. The system will also inform the patient by visual and sound alarm of the need to take medication. In the case of a medication treatment regimen failing, there will be certainty that the patient indeed took the medication as prescribed. The system will also facilitate the elderly who don't have a caregiver at home regularly to have their medications refilled regularly without having to make a phone call or go to the pharmacy.

Additional features of the disclosure will become apparent to those skilled in the art upon consideration of the following detailed description of the illustrative embodiment.

### BRIEF DESCRIPTION OF THE DRAWINGS

The detailed description particularly refers to the accompany figures in which:

FIG. 1 shows an illustrative embodiment of a personal medication regimen control system having a container, display, keys, and recesses for medication;

FIG. 2 shows the bottom side of the system of FIG. 1 with the end bottom of the recesses;

FIG. 3 shows an end view of the system of FIG. 1 with the container lid open;

FIGS. 4 and 5 illustrate one of the possible types of medication sensors arrangements for the system of FIG. 1;

FIG. 6 illustrates the electrical and operational structure of the microcontroller of the system of FIG. 1; and

FIG. 7 illustrates the system battery.

### DESCRIPTION OF THE ILLUSTRATIVE EMBODIMENT

For the purposes of promoting and understanding the principles of the invention, reference will now be made to one or more illustrative embodiments shown in the drawings and specific language will be used to describe the same.

The present disclosure is directed to a container of variable size determined according to demand for convenience and utility. The container will contain enough space to keep all the different types of medication a particular patient takes on a daily regular basis. The average size of the container can be determined by the average number of medications taken daily for a certain population. The average container can include about 12 recesses.

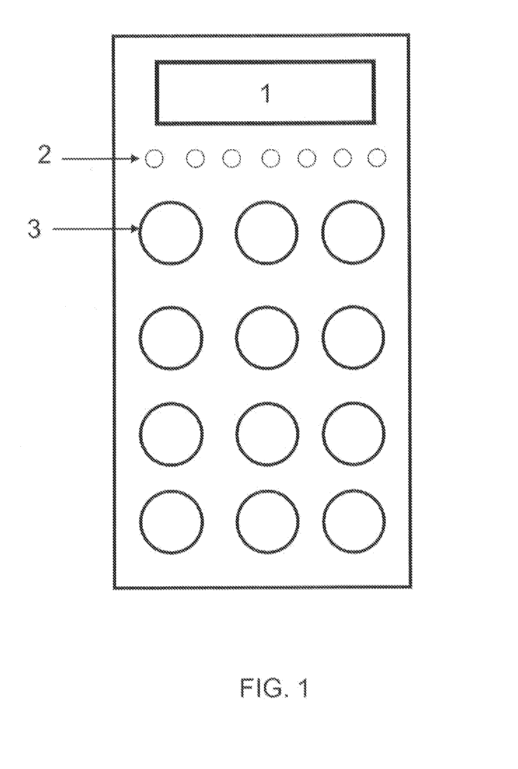

The outer aspects of an illustrative embodiment of the container is shown in FIG. 1. The illustrative embodiment includes a cover or lid and is sized to hold 12 different types of medication. The container can be made of acrylic, plastic or metal and layered inside with more sophisticated materials such as leather, velvet, etc, according to manufacturer's preference, without altering the basic features and functions of the container. The container has multiple compartments and each compartment can hold one type of medication.

A display 1 can be embedded in the container which will display instructions regarding the medications, and a sounding beep, or a recorded or synthesized voice sound will warn the patient simultaneous with instructions in the display, when it is the date and time to take a certain medication. In some more complex embodiments, a small elementary cell phone system can be part of the container and will generate phone calls to preprogrammed phone numbers such as the patient, relative, caregiver, doctor, nurse, pharmacist or even emergency medical system.

The device for personal control of chronic or eventual use medications is made of the structures depicted in the figures.

FIG. 1 shows the frontal aspect showing the lid of the container with the shape of the recess, which can contain one type of medication each.

As mentioned above, the number or size of the recesses do not alter its function or the technical and inventive content of the system.

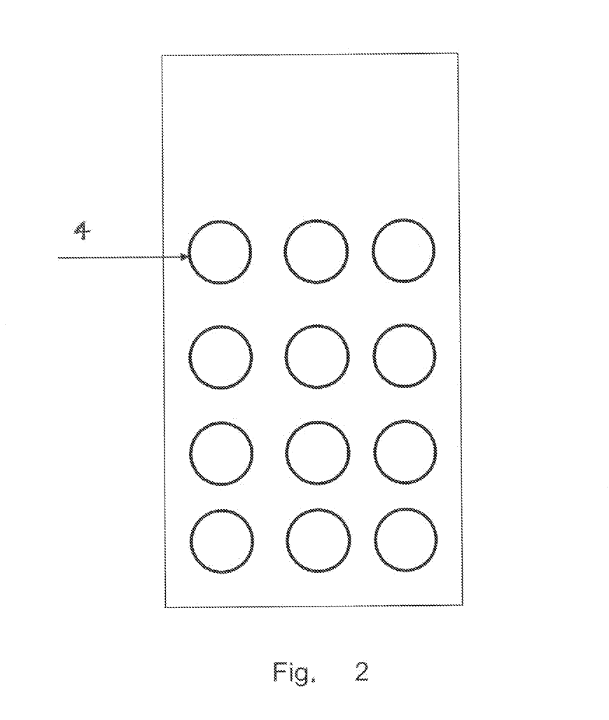

FIG. 2 illustrates the bottom of the container with the end bottom of the recesses 4 shown which will contain an electric contact which is the basis of the signal output for touch sensors using a conducting rubber or metal or any other material capable of completing a circuit that will detect the presence of medication in the interior of the recess. Each recess will be marked by a number in the inside and the outside of the container in order to limit errors of detection or location of the medication in the container.

The type of sensor used is not significant for the utility and the function of the invention. A simple presence touch sensor could be used, or a closed contact sensor to detect the presence of an element in the recess, in this case, the medication. Depending on the type of sensor used in an embodiment, a matching conducting element can be installed in the bottom of the container, one in each recess, in order to relay the information to the microcontroller of the container.

Shown in FIG. 1, a group of keys 2 allows programming that will guide the time of use of the medications contained in the container, as well as the order of the visual and sound alarms that will remind the user of dates and times at which each medication should be taken.

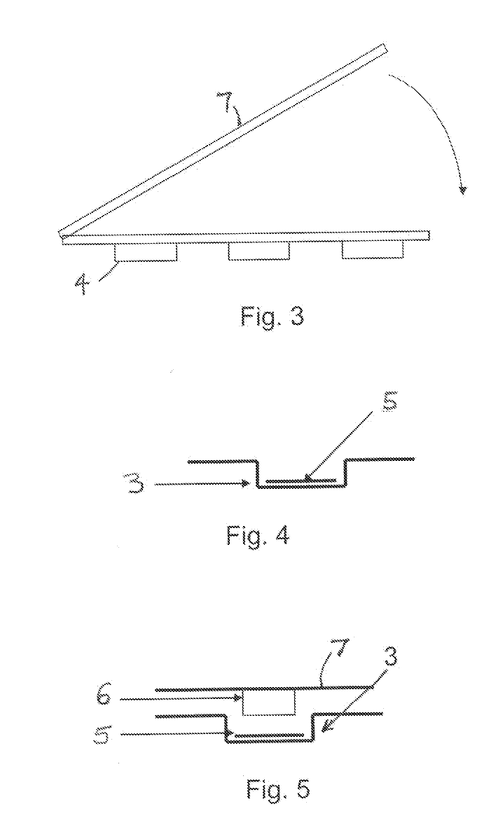

FIG. 3, represents an end view of the product with the lid 7 open. The depth of the recesses has been compressed in this view. Again, dimensions of the physical aspects of the container can be determined at manufacturing time.

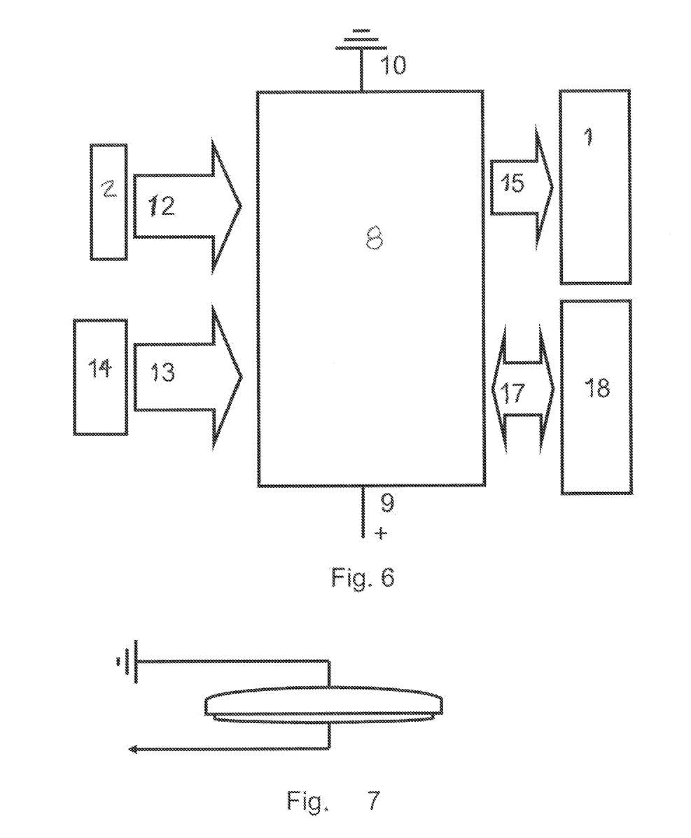

FIGS. 4 and 5 illustrate one of the possible types of sensors arrangements that would detect the existence of each medication inside its selected recess. In this example, sensing occurs by the circuit being completed by closing of the contact between the sensor element 5 in the bottom of the recess 3 (FIG. 4) and the sensor element 6 associated with the recess lid 7 (FIG. 5) once the recess is empty or without any medication. Once the electrical circuit between sensor elements 5 and 6, illustrated in FIG. 5, is closed, information will be relayed to the control circuit of the device depicted on FIG. 6. Then, according to the programming of the microcontroller, the visual and/or sound alarms will warn of the need to refill the specific recess. This will happen when the sensor signal indicates the recess is empty, leading to the visual information on the display and or audible signal that a certain medication needs to be refilled. At this point, the warning will sound or display at regular intervals and will only stop when the medication is replenished in the recess.

When the medication is replenished, the keys 2 shown in FIG. 1 are used to enter information regarding the regimen for the medication, and the microcontroller then will sound the alarms when it is time to take a certain medication

FIG. 6 illustrates the electrical and operational structure of the controlling circuit. Microcontroller 8, the controller of the system, is able to receive the instructions and information in the following way:

The channels 12 bring information to the microcontroller coming from the keys 2. Instructions entered via the keys will be transferred into the program of the microcontroller whose memory (firmware) will have the necessary space and basis to receive all the data entered to perform all the specific functions of each embodiment.

Input 13 from the sensors 14 inside the recesses detects if each one of the recesses contains the set medication or if any recess is empty. This will lead the microcontroller to respond in the pre-programmed way.

Communication channel 15 from the controller to the display 1 on which information and instructions can be displayed along with other informative elements that will help or guide the input of the necessary information for proper functioning of the device.

Display 1 receives and displays the visual and or sound information according with the information and instructions that were inserted in the controlling elements regarding the medications to be taken at certain times.

An extra feature of external communication channel 17 that some embodiments can have will provide communication with an external device 18 such as a personal computer or with a cellular telephone, or even an attached cellular element in the system that allows external control or viewing by a caregiver, nurse, pharmacist or physician. Communication method 17 and the attached or external device 18 will allow not only outward transfer of information, but also inward influx of information or even additional convenient changes to instructions to enhance or improve its functionality.

The system battery of adequate size, probably similar to a watch battery or button battery is shown in FIG. 7. The battery provides power supplies 9 and 10 for the microcontroller 1 and the whole system as shown in FIG. 6.

1. Personal medication control system, comprising:
a container defining a plurality of separate recesses enclosed by a lid and receiving of a variable amount of different medications;
an electronic control that provides the detection of the presence and absence of the medications in the plurality of recesses, receiving information about medication regimens, the capacity to warn the user of when to take each medication, and warning of the need to refill each medication.

2. The personal medication control system of claim 1, wherein the regimen includes the times and dates to take each different medication.

3. The personal medication control system of claim 1, wherein the container is in the shape of a pocket scheduler.

4. The personal medication control system of claim 1, wherein the plurality of recesses are sized according to different sizes of each medication.

5. The personal medication control system of claim 1, wherein the electrical control further comprises display and sound elements, and wherein the warning the user of when to take each medication, and the warning of the need to refill each medication, include a visual display and sound warning.

6. The personal medication control system of claim 5, wherein the electrical control further comprises a communication connection to that allows the warning to be sent to third parties that are interested in one of the correct usage and the refill of the medications.

7. The personal medication control system of claim 1, wherein the electronic control provides detection of the presence of different medications in the plurality of recesses and instructions for the use of each medication.

8. The personal medication control system of claim 7, wherein the electronic control further comprises entry keys and medication instructions are entered into the electronic control using the keys.

9. The personal medication control system of claim 1, wherein the electronic control includes a digital controller that enables it to store, accept and identify medications in the plurality of recesses, and accept instructions to be programmed locally or remotely, according to medical instructions to allow accurate compliance with a set of instructions and allows changes to the instructions.

10. The personal medication control system of claim 1, further comprising a visual display and wherein the electronic control is able to receive and transmit data directly through the visual display in real time or remotely through a conventional communication system.

11. The personal medication control system of claim 1, further comprising a digital display that can show all the information pertinent to guide a user through different functions, and alert and guide the user in the accurate compliance with medical instructions.

12. The personal medication control system of claim 1, wherein the electronic control enables communication and informing through remote communications system.

13. The personal medication control system of claim 12, wherein the remote communications system is a cellular telecommunications network.

14. The personal medication control system of claim 1, wherein the electronic control further comprises a first sensor element located in the bottom of each of the plurality of recesses for the detection of the presence and absence of the medications.

15. The personal medication control system of claim 14, wherein the electronic control further comprises a second sensor element coupled with the lid and associated with each of the plurality of recesses, and detection of the absence of medication in each of the plurality of recesses is provided by an electrical circuit between the first and second sensor elements being completed due to the absence of medication.
